(19) United States
(12) Patent Application Publication
(10) Pub. No.: US 2005/0200699 A1
(43) Pub. Date: Sep. 15, 2005

(54) Multi-functional cable and fishing equipment with video system and underwater image video system using the same

(76) Inventor: Mu-Joong Kim, Padong Soosung-gu Daegu (KR)

Correspondence Address: BLANK ROME LLP, 600 NEW HAMPSHIRE AVENUE, N.W., WASHINGTON, DC, 20037, US

(21) Appl. No.: 10/517,050

(22) PCT Filed: Jun. 5, 2003
(86) PCT No.: PCT/KR03/01103

§ 371 Date: Dec. 3, 2004

(30) Foreign Application Priority Data
Jun. 5, 2002 (KR) 10-2002-0031738
Aug. 16, 2002 (KR) 20-2002-0024492

(51) Int. Cl. H04N 7/18

(52) U.S. Cl. 348/81

(57) ABSTRACT

Disclosed is a multifunctional cable, and fishing equipment and underwater image video system using the same. The multifunctional cable according to the present invention comprising electric cords, a image signal cord and one or more control cords to transfer signals of sounds, supersonic waves, temperature information or control orders with individual inner coats, and exterior of these cords are molded or filled with flexible and durable molding resin or fibers, and the outer surface of the cable is covered with an abrasion resistant coat. On the other hands, the fishing equipments with video system and underwater image video systems according to the present invention and the devices of the photographing part under the water and external device part out of the water are connected with each other using said multifunctional cable.

### TECHNICAL FIELD

The present invention relates to a multifunctional cable, and fishing equipment and underwater image video system using the same, and more particularly to a multifunctional cable which has both capability and durability due to several micro wires included, and fishing equipment and underwater image video system using the same.

### BACKGROUND ART

Recently, there have been many efforts to develop fishing equipment with underwater image photographing systems, which would enhance the experience by allowing the user to observe the underwater environment by way of the video system attached to the fishing equipment.

For example, the Korean Patent Publication of registration No. 1988-76867 discloses fishing equipment that enables the user to watch images sent from underwater video camera to an external display device through electric wire while staying out of water.

But in reality, this concept is still not on a practical level, thus things like fishing while observing the underwater conditions and environment hasn't come true yet.

That is because all underwater photographing and transmitting system including fishing equipment with image system require some kinds of channels that can send and receive signals. These channels are needed to send underwater image signals out of the water and receive these signals to display them on the display device. Of course, it is impossible to use the conventional fishing lines or general electric wires for this purpose. In other words, to construct fishing equipment with underwater image photographing system, the cable has to be thin, durable, and flexible at the same time in order to send/receive various signals including image signals.

The present invention is designed to provide a multifunctional cable that has all the characteristics needed in a fishing line such as fineness, flexibility and durability, and also has the capability of sending/receiving of electricity and image signals as mentioned above. Another purpose of the present invention is to provide fishing equipment with video system and underwater image video system using the above mentioned multifunctional cable, which enables the user to photograph the underwater environment and fish effectively.

### DISCLOSURE OF INVENTION

The multifunctional cable that accomplishes the above mentioned purpose is characterized that comprising:
electric cords, a image signal cord and one or more control cords to transfer signals of sounds, supersonic waves, temperature information or control orders with individual inner coats, and exterior of these cords are molded or filled with flexible and durable molding resin or fibers, and the outer surface of the cable is covered with an abrasion resistant coat.

Said control cord is used to channel signals of sounds, temperature information, and control order, etc. and several may be included in a multifunctional cable according to the function needed. But it is also possible to manufacture multifunctional cable according to the present invention without control cords. This is because sometimes according to the usage, it is possible to achieve the purpose by using multifunctional cables without control cords. For example, there are cases when the user only needs image signals.

On the other hand, all fishing equipments with video system and underwater image video systems according to the present invention are characterized that using above mentioned multifunctional cables according to the present invention.

The first embodiment of the fishing equipment with video system according to the present invention is characterized that comprising:
multifunctional cable according to the present invention;
a photographing part comprised of a weight connected to one end of the multifunctional cable, having a built-in camera and one or more control devices selected from supersonic wave sensor, digital temperature sensor, underwater mike, pressure sensor, vibrating motor, geomagnetic sensor and camera angle adjustor and several tying rings for the fishhook are formed; and a buoyancy regulating float connected to a point of said multifunctional cable;
an external device part connected to the other end of said multifunctional cable, and comprised of a display panel which receives and displays various signals including image signals from said photographing part through said multifunctional cable, a controller communicating to the control devices through the multifunctional cable and controls them by exchanging control signals through the multifunctional cable, and an electric power supplier which supplies power to the above photographing part, display panel and controller.

The second embodiment of the fishing equipment with video system according to the present invention is characterized that comprising:
a photographing part comprised of a weight connected to one end of the multifunctional cable according to the present invention, having a built-in camera, one or more control devices selected from supersonic wave sensor, digital temperature sensor, underwater mike, pressure sensor, vibrating motor, geomagnetic sensor and camera angle adjustor, several tying rings for the fishhook are formed, and a wireless radio sending/receiving float connected to said weight through said multifunctional cable and including a first radio sending/receiving circuit having an electric power supplier inside; and
an external device part comprised of a second radio sending/receiving circuit exchanging signals with the first radio sending/receiving circuit; a display panel connected to the second radio sending/receiving circuit, and receives and displays various signals including image signals received by the second radio sending/receiving circuit from said photographing part; a controller connected to the second radio sending/receiving circuit and controls the control devices by exchanging control signals through the second radio sending/receiving circuit; and an electric power supplier which supplies power to the second radio sending/receiving circuit, display panel and controller.

The third embodiment of the fishing equipment with video system according to the present invention is characterized that comprising:
multifunctional cable according to the present invention;
a photographing part comprised of a weight connected to one end of the multifunctional cable, having a built-in camera and one or more control devices selected from supersonic wave sensor, digital temperature sensor, underwater mike, pressure sensor, vibrating motor, geomagnetic sensor and camera angle adjustor, several tying rings for the fishhook are formed; and a buoyancy regulating float connected to a point of said multifunctional cable;
a wireless transceiver connected to the other end of said multifunctional cable, having a first radio sending/receiving circuit with an electric power supplier inside and fixable to a point outside the water; and
an external device part comprised of a second radio sending/receiving circuit exchanging signals with the first radio sending/receiving circuit; a display panel connected to the second radio sending/receiving circuit, and receives and displays various signals including image signals received by the second radio sending/receiving circuit from said photographing part; a controller connected to the second radio sending/receiving circuit, and controls the control devices by exchanging control signals through the second radio sending/receiving circuit, and controls the display panel; and an electric power supplier which supplies power to the second radio sending/receiving circuit, display panel and controller.

And, it is possible to choose only a type of control device from the control devices such as—a built-in camera, supersonic wave sensor, digital temperature sensor, underwater mike, pressure sensor, vibrating motor, geomagnetic sensor or camera angle adjustor—and install it inside the weigh, but it is also possible to choose two or more devices and install them all.

With the fishing equipment with video system according to the present invention, the preferred shape of the weight case can be a bisected case or a lure shaped case. Said bisected case has a hinge on one side and a fixing flange on the other side of the case, thereby integrated and disintegrated using fixing bolts.

And whether the shape of the weight case is a lure shape or a bisected case shape, it is desirable that the bottom part of the weight is filled with materials of high density, the middle part has a built-in camera and control devices, and the upper part has a void, so that the weight always stand stably under the water.

It is also desirable to have a underwater float at a point of the multifunctional cable connecting the weight and the buoyancy regulating float or the wireless radio sending/receiving float, and one or more supplementing weight hung to the ring attached to the bottom of the weight case, thereby prevents the weight from fluctuating under the water and helps to regulate the density of the weight.

On the other hand, it is recommended to have a flexible tube or a thin wire on the weight, thereby make it possible to control the location of the fishhook and shooting angle of the camera.

Also, a preferred form of the camera angle adjustor of the fishing equipment with video system according to the present invention may be the [symbol] shaped fixtures, driven by a motor installed in the weight and installed so as to place each end of the fixture at each end of the weight case on the upper part of the weight, thereby the camera angle is adjustable to any angle by driving said fixture through controlling the rotating direction of the motor by using the controller of the external device part.

On the other hand, a point of the multifunctional cable between said weight of the photographing part and the float may be cut and a connector be installed to connect them, thereby the user can exchange the weight of the photographing part whenever needed.

On the other hand, the first embodiment of the underwater image video system according to the present invention is characterized that comprising:
multifunctional cable according to the present invention;
a photographing part comprised of a photographing device connected to one end of the multifunctional cable, having a built-in camera and one or more control device selected from supersonic wave sensor, digital temperature sensor, underwater mike, pressure sensor, geomagnetic sensor and camera angle adjustor inside; a diver's location indicating buoy connected to a point of said multifunctional cable; and a winding reel used to control the length of the multifunctional cable between the buoy and the photographing device according to the distance between the water surface and the diver;
an external device part connected to the other end of the above multifunctional cable and comprised of a display panel which receives and displays various signals including image signals from the photographing part through the multifunctional cable, a controller communicating with the control devices through the multifunctional cable and controls the control devices by exchanging control signals through the multifunctional cable, and an electric power supplier which supplies power to the above photographing part, display panel and controller.

The other embodiment of the underwater image video system according to the present invention is characterized that comprising:
a photographing part comprised of a photographing device connected to one end of the multifunctional cable according to the present invention, having a built-in camera and one or more control devices selected from supersonic wave sensor, digital temperature sensor, underwater mike, pressure sensor, geomagnetic sensor and camera angle adjustor inside, a diver's location indicating buoy connected to the other end of the above multifunctional cable, having a first radio sending/receiving circuit inside, and a winding reel used to control the length of the multifunctional cable between the buoy and the photographing device according to the distance between the water surface and the diver;
an external device comprised of a second radio sending/receiving circuit exchanging signals with the first radio sending/receiving circuit; a display panel connected to the second radio sending/receiving circuit and receives and displays various signals including image signals received by the second radio sending/receiving circuit from the photographing part; a controller connected to the second radio sending/receiving circuit and controls the control devices by exchanging control signals through the second radio sending/receiving; and an electric power supplier which supplies power to the second radio sending/receiving circuit, display panel and controller.

Additionally, it is recommended to install a twin lens reflex on the exterior case of said photographing device, composed of a case of each end open and with at least one or more curves, a hinge installed on the curved part of the above case, and a reflector installed on the curved part to reflect the incident ray to a set degree.

The camera angle adjustor of the underwater image video system may be the same as that of the above fishing equipment with video system according to the present invention, and if this kind of angle regulator is applied, it is possible for the diver to fix the photographing device on a point under the water, come out of the water, and watch the underwater environment for a long time from out of the water.

### BRIEF DESCRIPTION OF DRAWINGS

FIG. 1 is a cross sectional view of the internal structure of the multifunctional cable according to one preferred embodiment of the present invention;

FIG. 2 shows the usage state of a whole composition of the fishing equipment with video system according to one preferred embodiment of the present invention;

FIG. 3 is a cross sectional view that shows the detail composition of the weight of the photographing part of the fishing equipment with video system according to one preferred embodiment of the present invention;

FIG. 4(a) and FIG. 4(b) are side cross sectional views that show the weight of the photographing part of the fishing equipment with video system according to some preferred embodiments of the present invention;

FIG. 5(a) and FIG. 5(b) are cross sectional views that show the whole composition of the photographing part of the fishing equipment according to some preferred embodiments of the present invention;

FIG. 6(a) and FIG. 6(b) are structural views that show the various structures of the external device part of the fishing equipment with video system according to the present invention;

FIG. 7 shows the usage state of a complete composition of the underwater image video system according to the present invention;

FIG. 8 is a cross sectional view of the photographing device of the underwater image video system according to the present invention;

FIG. 9 is a side cross sectional view of the twin lens reflex of the underwater image video system according to the present invention;

FIG. 10 is a cross sectional view that shows the entire structure of the buoy of one preferred embodiment of the underwater image video system according to the present invention.

### BEST MODE FOR CARRYING OUT THE INVENTION

Now, preferred embodiments of the present invention will be described in detail with reference to the annexed drawings.

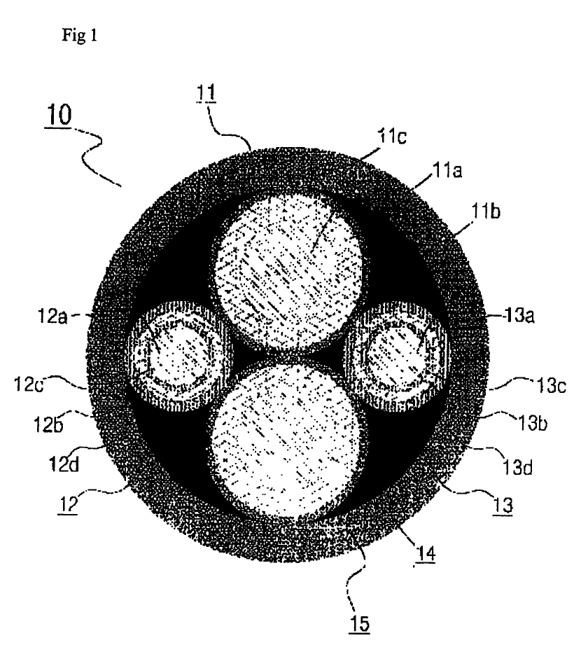

FIG. 1 is a cross sectional view of the internal structure of the multifunctional cable according to one preferred embodiment of the present invention. As shown in FIG. 1, the multifunctional cable 10 according to the present invention has two strands of electric cords 11 that channel electricity, a image signal cord 12 that channels image signals and a control cord 13 that channels control signals inside, all of which have inner coats 11c, 12d, 13d on their surfaces respectively, arranged in a stable manner; and the outside of above cords is molded with flexible and durable molding resin 14; and outer surface of the molding resin is coated with an abrasion resistant exterior coat 15 again.

The image signal cord 12 and control cord 13 have inner lines 12a, 13a and outer lines 12b, 13b respectively; and insulating layers 12c, 13c are formed between them; The electric cords 11 also have the inner lines 11a and outer lines 11b, but do not have insulating layers between them 11a, 11b.

Also as shown in FIG. 1, it is desirable to apply different diameters to the electric cords 11, and, image signal cord 12 and control cord 13 inside the cable 10, thereby prevent the cords 11, 12, 13 from getting twisted.

The multifunctional cable 10 needs to be light and durable like the fishing line and must be able to channel electricity and signals at the same time. So a recommended specification of multifunctional cable suitable for standard specifications of a high definition CCD DC 12V, 250 mA may be as shown in Table 1.

TABLE 1

| | | | Image Signal Cords/ | |
|---|---|---|---|---|
| Item | | Unit | Control cords | electric cords |
| Number of cores | | number | 1 Each | 2 |
| Inner Lines | Material | | Silver Plated Copper | Tin Plated |
| | | | | Copper |
| | Diameter | mm | 0.12 | 0.306 |
| Insulating | Material | | Teflon | |
| Layer | Diameter | mm | 0.307 | |
| Outer Lines | Material | | Tin Plated Copper | Tin Plated |
| | | | | Copper |
| | Thickness | mm | 0.03 | 0.65 |
| Inner coat | Material | | Teflon | PE or PP |
| | Diameter | mm | 0.46 | |
| Molding | Diameter | mm | 0.92 | |
| Resin | Material | | Kevlar or | Kevlar or |
| | | | Carbon Resin | Carbon Resin |
| Exterior coat | Material | | PE or PP | |
| | Diameter | mm | 1.5 | |

According to Table 1, the recommended materials for the cords used in the multifunctional cable according to the present invention are; Tin plated copper for the electric cords 11, silver plated copper for the inner line 12a, 13a and tin plated copper for the outer line 12b, 13b of the image signal cord 12 and control cord 13 are used, and a Teflon insulating layer 12c, 13c is formed between said inner lines 12a, 13a and outer lines 12b, 13b.

The electric cord 11 formed as above uses polyethylene (PE) or polypropylene (PP), and the image signal cord 12 and control cord 13 use Teflon to form an inner coat and complement the insulation and hardness.

These electric cords 11, image signal cord 12 and control cord 13 are united using molding resin 14 or the voids between the cords 11, 12, 13 are filled with molding resin 14 having flexibility, excellent tensile properties and high durability like Kevlar fibers or carbon resin, then, the exterior coat 15 is formed using abrasion-resistant and flexible resin like polyethylene or polypropylene.

By using the structure and material composition mentioned above, it is possible to make the multifunctional cable 10 according to the present invention have a total cable diameter of 1.5 mm, an electric cord 11 have a diameter of 0.306 mm, an image signal cord 12 and control cord 13 have a diameter of 0.12 mm, and still have the characteristics of a electric cord and flexibility and durability at the same time.

On the other hand, as stated above, the number and dimensions of the image signal cords and control cords mentioned above may be changed according to its use, and this kind of change is also regarded as belong to the scope of the present invention.

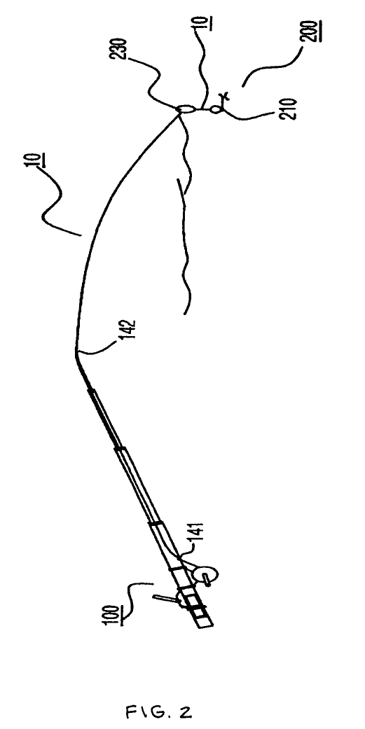

Now, a preferred embodiment of the fishing equipment with video system according to the present invention will be explained by referring to FIGS. 2 to 6 which show the structure of fishing equipment with video system according to this invention.

As shown in FIG. 2 to FIG. 6(a), (b), the fishing equipment of this example is composed of a photographing part (200) comprising a weight 210 having a camera 220 and control device 213 inside, and a float 230, thereby photograph the underwater environment; an external device part 100 comprising display panels 110, controllers 120 and electric power suppliers 130, thereby display images taken by the photographing part 200 and control the control devices 213; and a multifunctional cable 10 that connects the devices mentioned above.

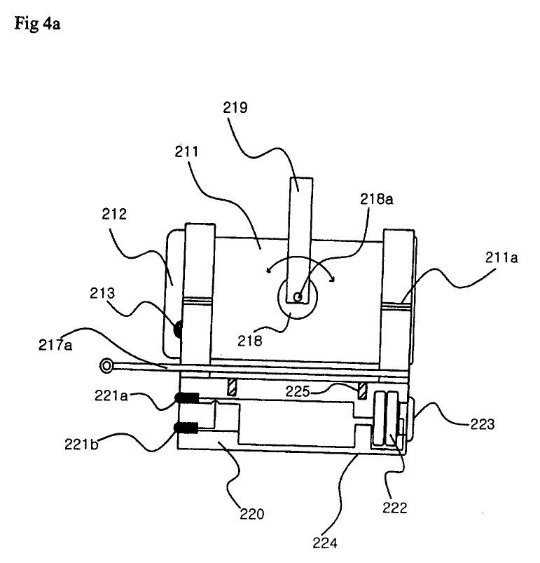

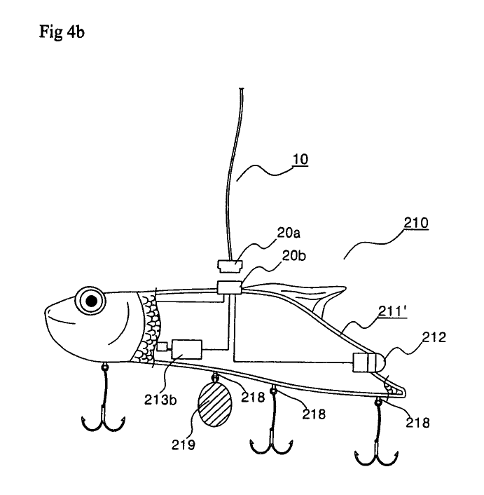

As shown in FIG. 4(b), the multifunctional cable between the weight 210 and float 230 of the photographing part can be cut, and a connecter 20a, 20b can be installed to connect two ends of the cut multifunctional cable. This make it easy for the user to change the weight 210 whenever needed.

Also, the weight 210 of the photographing part 200 may be made in various shapes. As shown in FIG. 4(a) and (b), bisected case shape 211 and known lure shape case 211 may be desirable.

The bisected case shape 211 mentioned above has a hinge 21 la on one part, a fixing flange 211b on the other part, and two parts of the case are combined together by using a fixing bolt 211c. A Lure shape 211′ means that the case of the weight has lure shape, and when this type of weight shape is adopted, the camera 212 should be placed in the back so that the attack of fishes cannot destroy the camera.

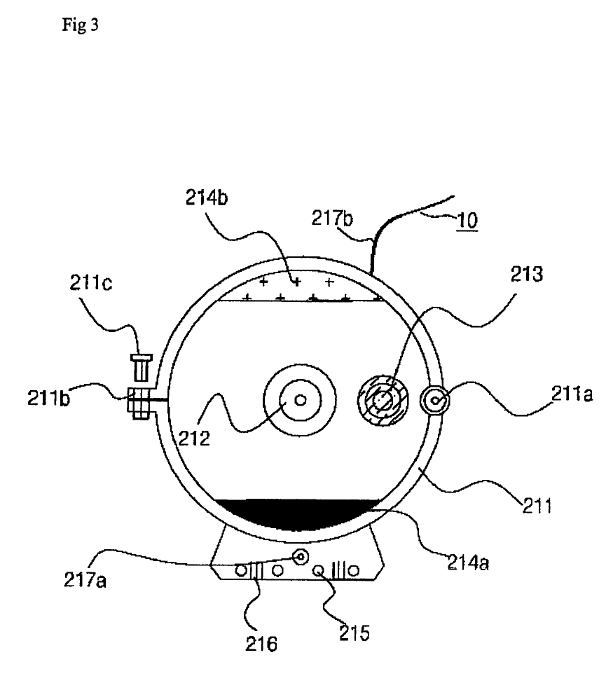

As shown in FIG. 3, it is possible to outfit several tying rings 215 and fixing grooves 216 on the surface of the case 211, which help the tying of the fishing line 10 and fishhook and installing of the lighting systems 220. And inside of the case, a camera 212 for underwater photographing and control devices 213 are built in.

One or several devices can be chosen and attached together selected from the group of built-in camera, supersonic wave sensor, digital temperature sensor, underwater mike, pressure sensor, vibrating motor, geomagnetic sensor and camera angle adjustor as the control device 213. With these control devices 213, the user can check the temperature, pressure, depth, current and sound of the water and find a school of fish from outside of the water. And by using the camera angle adjustor, the user can control the angle of the camera and shot the underwater environment much more precisely.

Among the control devices mentioned above, the digital temperature sensor, underwater mike, pressure sensor, vibrating motor, and geomagnetic sensor can be one of the known micro type devices; wherein sensing parts of the pressure sensor, temperature sensor, and geomagnetic sensor should be exposed to the surface of the weight case because they need contact with water.

Especially as shown in FIG. 4(b), if a vibrating motor 213b is installed as a control device 213 to the lure shaped weight 211′, the lure shaped weight 211′ swims under the water according to the vibration of the vibrating motor 213b and this allures the carnivorous fishes because this lure formed weight 211′ may seem like a real live fish to them.

Also, as shown in FIG. 4(a), the camera angle adjustor is built by installing the [symbol] shaped fixture 219 driven by a motor 218 installed inside the weight 210, as to place each end of the fixture at each end of the weight case on the upper part of the weight. So the camera angle is adjustable to any angle by the drive of the above mentioned fixture 219 by controlling the rotating direction of the motor 218 through the controller 120 of the external device part 100.

Also, in this invention, the case 211 of the weight 210 mentioned above has different density to prevent the current to shake the camera and to knock it off focus. In this example, the bottom part is filled with high-density material 214a, a camera 212 and control system 213 are built in the middle part, and an empty space 214b is formed in the upper part as shown in FIG. 3. The difference of the density of each part makes the weight 210 always stand under the water.

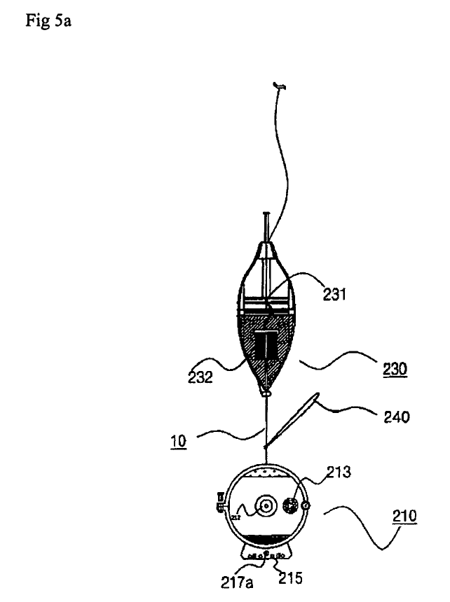

And as shown in FIGS. 5(a) and (b), It is possible to equip a underwater float between the weight 210 and buoyancy regulating float 230 connected by the multifunctional cable 10, thereby prevent the weight 210 from fluctuating, and to hang one or more supplementing weight 219 to the ring 218 attached to the bottom of the weight, thereby make it easy to regulate the density and the diving depth of the weight 210.

Lighting 220 provided for this weight 210 is composed of an illuminator 221a, 221b, batteries 222 and a switch 223 inside a sealed case 224 as shown in FIG. 4. One or more illuminators can be chosen and attached from the high luminance illuminating diode 221 a or the infrared light 221b according to the use.

On the case 224 mentioned above, there are fixing holes 225 corresponding to the fixing grooves 216 formed on the weight 210's case 211, so that they can be connected together with bolts.

The weight 210 and float 230 are connected together by the multifunctional cable 10 according to the present invention. And as shown in FIG. 3 and FIG. 4(a), certain length of flexible tube 217b or thin wire 217 a is installed, which allows the location of the camera angle and fishhook to be adjustable.

If the user bends the flexible tube 217b or thin wire 217a to a certain degree before putting the photographing part 200 under the water, the camera 212 in the weight 210 forms a fixed shooting angle under the water, and the fishhook also stays at a certain point under the water.

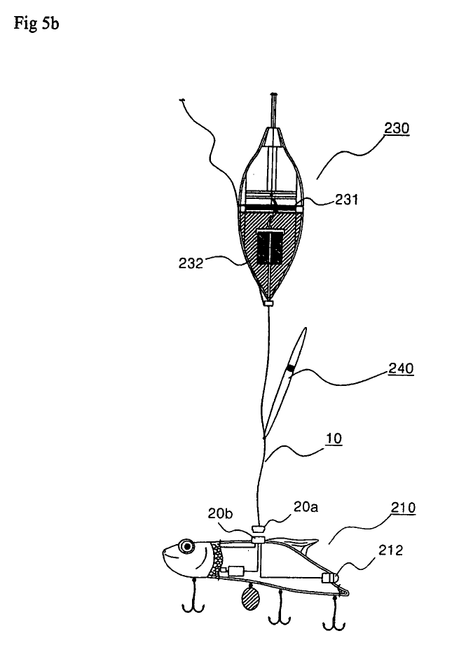

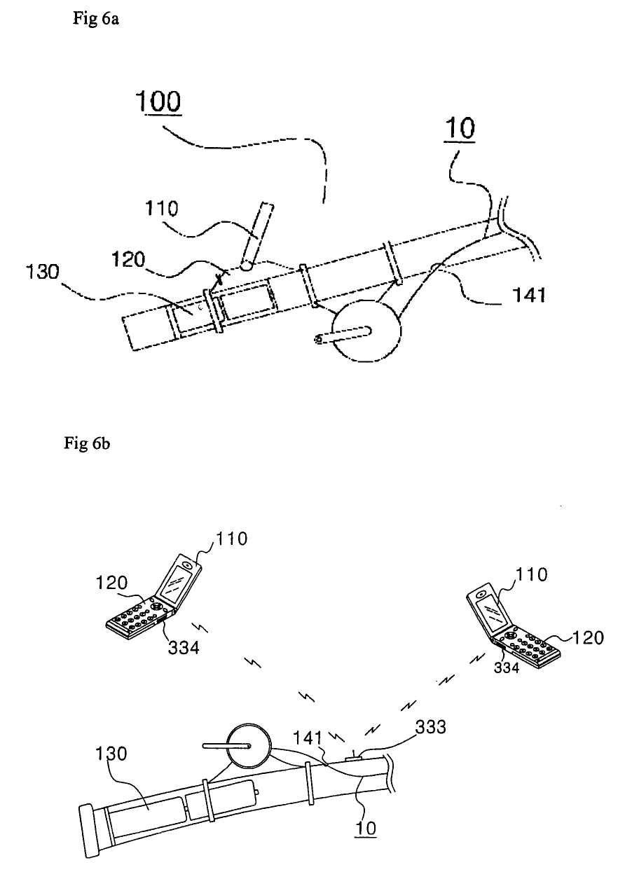

As shown in FIG. 6(a), the external device part 100 connected to the photographing part 200 mentioned above, is composed of a display panel 110, controller 120 and electric power supplier 130, thereby displays images shot by the photographing part 200, operates the control devices, and supplies electric power to the devices. Wherein, the controller 120, display panel 110 and electric power supplier 130 may be integrated form or separate form. And, the external device part may be attached to the fishing pole and integrated with it as shown in the present example, or made separately from the fishing pole as a separate equipment

As shown in FIG. 6(b), if these devices of external device part 100 are used separately from the fishing pole, the external device part 100 can be composed effectively with the known mobile phone with power supply unit, display unit, input unit, image storage unit and control unit, by adding a connector to connect with the end of the multifunctional cable, or by installing a radio sending/receiving circuit 334 which exchange signals such as image signal with the wireless radio sending/receiving float of the photographing part or the wireless transceiver inside, or by adding or installing both of the above mentioned means to be used optionally by the user. In this case, the underwater images sent to the mobile phone can be sent to other places via mobile Internet and so on. And it is also possible for several people to watch underwater images from different spots by installing several external device parts 100.

And, the above mentioned electric power supplier 130 is composed of known adaptor and batteries, and the well-known technology related to the display technology can be applied to the construction and installation of external device part 100 especially power supplier 130, so the detailed drawings and explanations are omitted in this specification.

The photographing part 200 and external device part 100 with the above mentioned constructions are connected with each other by different means according to the communication type. If the wireless radio communication system is adapted, the photographing part 200 and external device part 100 with radio sending/receiving circuits 231 having an electric power supplier, are connected with each other by normal fishing lines as shown in FIG. 5(a). But if the wire communication system is adapted, the photographing part 200 and external device part 100 without radio sending/receiving circuits 231, are connected with each other by multifunctional cables according to the present invention, thereby channel signals and electric power through them.

On the other hand, if a little modification is added to these devices, it is possible to compose a fishing equipment with wireless type video system by equipping an individual wireless transceiver 333 having a first radio sending/receiving circuit, and connecting it with buoyancy regulating float of the photographing part 200 similar to that of above mentioned wire type, and then attaching it to one spot out of the water, desirably to a spot on the fishing pole, more desirably to a spot on the grip part of the fishing pole and making the other devices of the external device part 100 such as controller, display panel into portable type with a second radio sending/receiving circuit inside, so that said radio sending/receiving circuits (the first and second radio sending/receiving circuit) communicate with each other.

Addition to the above mentioned construction, by forming an inlet hole 141 and an outlet hole 142 on the fishing pole at the starting point and extruding point of the cable respectively, thereby make the multifunctional cable 10 pass through inside the fishing pole. By adapting this structure, it is possible to prevent the cable 10 getting tangled outside the fishing pole, and to make it easy to carry with.

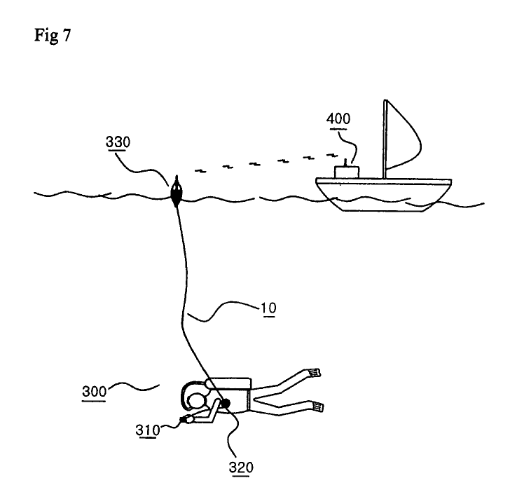

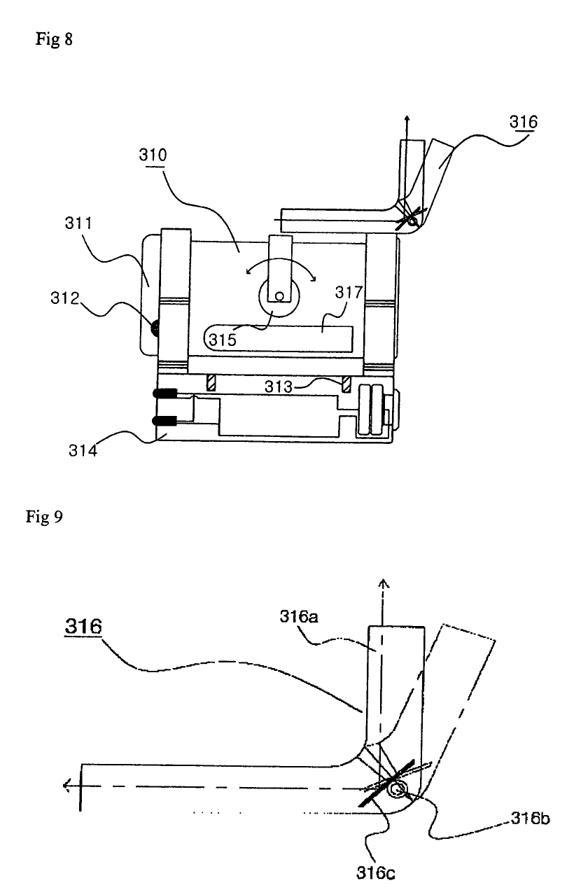

FIG. 7 shows the usage state view of a complete construction of the wireless type underwater image video system according to a preferred embodiment of the present invention; and FIG. 8 is a cross sectional view of the photographing device of the underwater image video system according to the present invention. Now, the desirable example of the underwater image video system according to the present invention will be described by referring to FIGS. 7 to 8

The underwater image video system according to the present example is composed of a photographing part 300 comprising a photographing device 310, winding reel 320, control devices 312 and a buoy 330 thereby take pictures of underwater environment, and a external device part 400 comprising display panels, controllers and an electric power suppliers thereby display images taken by the photographing part 300 and control the control devices 312.

As shown in FIG. 8, the photographing device 310 has fixing grooves 313 on the surface so as to install the lighting devices 314, and camera 311 for photographing underwater environment, control devices 314 such as supersonic wave sensor, digital temperature sensor, underwater mike, pressure sensor, geomagnetic sensor and camera angle adjustor similar to the weight 210 of the above mentioned fishing equipment with video system.

Addition to the above structure, the photographing device 310 has a fixing clip 317 and a twin lens reflex 316 outside of the device 310 to carry out more effective photographing. The fixing clip 317 is for the easy attaching/detaching of the photographing device 310 to the diving apparatus, so that the diver moves freely under the water without any restriction due to the photographing device 310. And the twin lens reflex 316 helps the diver to keep focus easily and to adjust the frame with observing the image being taken by the camera under the water.

As shown in FIG. 8, the twin lens reflex is composed of a case 316a, a hinge 316b to connect the cases and a reflector 316c. The case 316a has the shape of each end open to make it possible for the light to come in and out through the case, and has a curved part between the two ends. A hinge 316b is installed on the curved part for the case to be folded freely. And a reflector 316c is installed inside the case on the curved part, thereby the incident ray can be reflected and escape from the case to a certain degree. With the construction described above, the user can adjust the focus and frame of the camera 311 after observing the spot where the camera 311 is taking pictures through the twin lens reflex 316.

The photographing device 310 and the buoy 330 floated on the surface of water are connected with each other by the multifunctional cable 10 according to the present invention. Additionally, a winding reel 320 can be prepared between the photographing device 310 and the buoy 330 to make it easy for the diver to control the length of the multifunctional cable 10 according to the diving depth. To help the easy attaching/detaching of the winding reel 320 to the diving suit, it is desirable for the winding reel 320 to have a clip or so.

The external device part 400 connected to the photographing part 300 can be constructed similarly to that 100 of the fishing equipment with video system, and the functions of the devices are same for the most part, so the additional drawings and detailed explanations are omitted in this specification.

On the other hand, a kind of communicating path is necessary to exchange signals between the photographing part 300 and external device part 400. In this example, radio sending/receiving circuits are installed inside the buoy 330 and the external device part 400, which exchange information by wireless type.

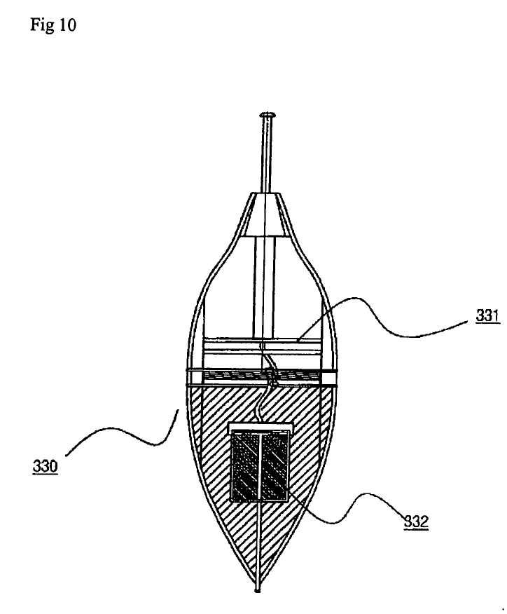

FIG. 10 shows the structure of a buoy 330 including radio sending/receiving circuit with electric power supplier 332 inside.

But, in the case that the photographing part 300 and external device part 400 are connected by a cable, there is no radio sending/receiving circuit in the buoy 330, and the electricity and signals are exchanged by using the multifunctional cable according to the present invention.

Also, although we have explained the cases where radio sending/receiving circuits were built in, but when the diver simply sends image signals and other underwater signals to the external device part 400, even simple type such as radio transmitting circuit is installed in the buoy 330 and radio receiving circuit is installed in the external device part 400 will be sufficient. These kinds of structure are also considered to be in the scope of this invention.

If the wireless type is adapted for the communication, it is possible to use general radio frequency, but it is more desirable to construct a network of 2.4 GHz radio circuit, and use several channels provided by the 2.3 GHz radio circuit network mentioned above to observe the underwater images taken by several divers at the same time.

Although we have explained about the example of wireless type underwater image video system with radio sending/receiving circuits, instead of using radio sending/receiving circuits mentioned above, it is possible to connect the buoy and the external device part 400 using the multifunctional cable according to the present invention and exchange signals through this cable. In this type of system, the other components excepting the radio sending/receiving circuit explained with the wireless type underwater image video system can be applied unchanged.

Also, the display and control functions using mobile phones on the fishing equipment with video system can be applicable.

Only some examples on how to use the multifunctional cable, the fishing equipment with video system and underwater image video system are explained above. But this description is not everything, and all simple modifications made to the technology concerning this invention are in the range of this invention.

### INDUSTRIAL APPLICABILITY

The multifunctional cable according to the present invention may be useful in many types of underwater image shooting systems including fishing equipment with video system, because it is composed of micro cords with flexibility and durability and possible to transmit electricity, image signals and control signals needed in the display devices and control devices, thereby possible to prevent the problems of conventional type of cables such as easy cutting or easy detection by the fishes.

Also, it is possible not only to carry out fishing or long time underwater photographing more effectively by using the fishing equipment with video system or underwater image video system according to the present invention, but also to observe the movements of schools of fish, to check the temperature and depth of the water and to listen to underwater sounds to capture the fishes.

Since the underwater image video system mentioned above can be made with low cost, it is expected that it will replace the previous high costing products. And since someone out of the water can watch what is happening under the water, accidents under the water can be prevented, and the fear that divers might have about water can be alleviated.

1. A multifunctional cable comprising;
electric cords, a image signal cord and one or more control cords to transfer signals of sounds, supersonic waves, temperature information or control orders with individual inner coats; and
exterior of these cords are molded or filled with flexible and durable molding resin or fibers, and the other surface of the cable is covered with an abrasion resistant coat.

2. The multifunctional cable according to claim 1 wherein the electric cords are tin plated copper lines and wherein the inner coat material of the electric cords is polyethylene or polypropylene; wherein the inner line is silver plated copper line and wherein the outer line of the image signal cord and control cord are tin plated copper lines and wherein the inner coat material of the image signal cord and control are Teflon; wherein the molding resin is Kevlar fibers or carbon resin; and wherein the abrasion-resist exterior coat material is polyethylene or polypropylene.

3. The multifunctional cable according to claim 1, wherein the diameter of the electric cords is different from the diameter of the image signal cord and control cord.

4. The multifunctional cable according to claim 3, wherein the diameter of electric cord is 0.306 millimeters (mm), the diameters of the image signal cord and the control cord are 0.12 mm, and the diameter of the whole multifunctional cable is less than 1.5 mm.

5. A multifunctional cable comprising:
electric cords and a image signal cord with individual inner coats; and
exterior of these cords are molded or filled with flexible and durable molding resin or fibers, and the outer surface of the cable is covered with an abrasion resistant coat.

6. The multifunctional cable according to claim 5 wherein the lines of the electric cords are tin plated copper lines and wherein the inner coat material of the electric cords is polyethylene or polypropylene; wherein the inner line is silver plated copper line and wherein the outer line of the image signal cord is tin plated copper line and wherein the inner coat material of the image signal cord is Teflon; wherein the molding resin is Kevlar fibers or carbon resin; and wherein the abrasion-resist exterior coat material is polyethylene or polypropylene.

7. fishing equipment with video system comprising:
a multifunctional cable comprising;
electric cords, a image signal cord and one or more control cords to transfer signals of sounds, supersonic waves, temperature information or control orders with individual inner coats; and
exterior of these cords are molded or filled with flexible and durable molding resin or fibers, and the outer surface of the cable is covered with an abrasion resistant coat;
a photographing part composed of a weight connected to one end of said multifunctional cable, having a built-in camera and one or more control devices selected from supersonic wave sensor, digital temperature sensor, underwater mike, pressure sensor, vibrating motor, geomagnetic sensor and camera angle adjustor and several tying rings for the fishhook are formed; and a buoyancy regulating float connected to a point of said multifunctional cable;
an external device part connected to the other end of said multifunctional cable, and comprised of a display panel which receives and displays various signals including image signals from said photographing part through said multifunctional cable, a controller communicating to the control devices through the multifunctional cable and controls them by exchanging control signals through the multifunctional cable, and an electric power supplier which supplies power to the above photographing part, display panel and controller.

8. fishing equipment with video system comprising:
a photographing part composed of a weight connected to one end of a multifunctional cable having a built-in camera, one or more control devices selected from supersonic wave sensor, digital temperature sensor, underwater mike, pressure sensor, vibrating motor, geomagnetic sensor and camera angle adjustor, several tying rings for the fishhook are formed, and a wireless radio sending/receiving float connected to said weight through said multifunctional cable and including a first radio sending/receiving circuit having an electric power supplier inside; and
an external device part comprised of a second radio sending/receiving circuit exchanging signals with the first radio sending/receiving circuit; a display panel connected to the second radio sending/receiving circuit, and receives and displays various signals including image signals received by the second sending/receiving circuit from said photographing part; a controller connected to the second radio sending/receiving circuit and controls the control devices by exchanging control signals through the second radio sending/receiving circuit; and an electric power supplier which supplies power to the second radio sending/receiving circuit, display panel and controller;
wherein the multifunctional cable comprises:
electric cords, a image signal cord and one or more control cords to transfer signals of sounds, supersonic waves, temperature information or control orders with individual inner coats; and
exterior of these cords are molded or filled with flexible and durable molding resin or fibers, and the outer surface of the cable is covered with an abrasion resistant coat.

9. fishing equipment with video system comprising:
a multifunctional cable comprising:
electric cords, a image signal cord and one or more control cords to transfer signals of sounds, supersonic waves, temperature information or control orders with individual inner coats; and
exterior of these cords are molded or filled with flexible and durable molding resin or fibers, and the outer surface of the cable is covered with an abrasion resistant coat;
a photographing part comprised of a weight connected to one end of said multifunctional cable, having a built-in camera and one or more control devices selected from supersonic wave sensor, digital temperature sensor, underwater mike, pressure sensor, vibrating motor, geomagnetic sensor and camera angle adjustor, several tying rings for the fishhook are formed; and a buoyancy regulating float connected to a point of said multifunctional cable;
a wireless transceiver connected to the other end of said multifunctional cable, having a first radio sending/receiving circuit with an electric power supplier inside and fixable to a point outside the water; and
an external device part comprised of a second radio sending/receiving circuit exchanging signals with the first radio sending/receiving circuit; a display panel connected to the second radio sending/receiving circuit, and receives and displays various signals including image signals received by the second radio sending/receiving circuit from said photographing part; a controller connected to the second radio sending/receiving circuit, and controls the control devices by exchanging control signals through the second radio sending/receiving circuit, and controls the display panel; and an electric power supplier which supplies power to the second radio sending/receiving circuit, display panel and controller.

10. The fishing equipment with video system according to claim 9, wherein the wireless receiver is fixed at a point of grip part of the fishing pole.

11. The fishing equipment with video system according to claim 7, further comprising a fishing pole with an inlet hole and an outlet hole at both end parts of the fishing pole respectively, so that the multifunctional cable can pass through the fishing pole.

12. The fishing equipment with video system according to claim 7, further comprising a connector which connects cut ends of the multifunctional cable between said weight of the photographing part and the float, so that the user can change the weight of the photographing part easily.

13. The fishing equipment with video system according to claim 7, wherein the case of said weight of the photographing part is known lure shape, and a built-in camera is built inside the lure.

14. The fishing equipment with video system according to claim 7, wherein the case of said weight of the photographing part is bisected case shape, which has a hinge on one side and a fixing flange on the other side of the bisected case, so that said bisected case can be integrated and disintegrated using fixing bolts.

15. The fishing equipment with video system according to claim 7, wherein the bottom part of said weight is filled with materials of high density, the middle part has a built-in camera and control devices, and the upper part has a void, so that said weight always stand stably under the water.

16. The fishing equipment with video system according to claim 7, further comprising certain length of flexible tube or a thin wire on the weight, so that the user can control the location of the fishhook and shooting angle of the camera.

17. The fishing equipment with video system according to claim 7, wherein the camera angle adjustor is constructed by installing the rectangular shaped fixture driven by a motor in the weight so as to place each end of said fixture at each end of the weight case on the upper part of the weight, so that the camera angle is adjustable to any angle by driving said fixture through controlling the rotating direction of the motor by using the controller of the external device part.

18. The fishing equipment with video system according to claim 7, further comprising a underwater float at a point of the multifunctional cable connecting the weight and the buoyancy regulating float or the wireless radio sending/receiving float, and one or more supplementing weight hung to the ring attached to the bottom of the weight case, so as to prevent the weight from fluctuating under the water and help to regulate the density of the weight.

19. The fishing equipment with video system according to claim 7, wherein the display panel, controller and electric power supplier of the external device part is constructed by adding a connector to connect with the end of the multifunctional cable or installing a radio sending/receiving circuit which exchange signals such an image signal with the wireless radio sending/receiving float of the photographing part or the wireless transceiver inside, to a known mobile phone with power and supply unit, display unit, input unit, image storage unit and control unit.

20. An underwater image video system comprising:
a multifunctional cable comprising:
electric cords, a image signal cord and one or more control cords to transfer signals of sounds, supersonic waves, temperature information or control orders with individual inner coats; and
exterior of these cords are molded or filled with flexible and durable molding resin or fibers, and the outer surface of the cable is covered with an abrasion resistant coat;
a photographing part comprised of a photographing device connected to one end of the multifunctional cable, having a built-in camera and one or more control device selected from supersonic wave sensor, digital temperature sensor, underwater mike, pressure sensor, geomagnetic sensor and camera angle adjustor inside; a diver's location indicating buoy connected to a point of said multifunctional cable; and a winding reel used to control the length of the multifunctional cable between the buoy and the photographing device according to the distance between the water surface and the diver;
an external device part connected to the other end of the above multifunctional cable and comprised of a display panel which receives and displays various signals including image signals from the photographing part through the multifunctional cable, a controller communicating with the control devices through the multifunctional cable and controls the control devices by exchanging control signals through the multifunctional cable, and an electric power supplier which supplies power to the above photographing part, display panel and controller.

21. An underwater image video system comprising:
a photographing part comprised of a photographing device connected to one end of the a multifunctional cable, having a built-in camera and one or more control devices selected from supersonic wave sensor, digital temperature sensor, underwater mike, pressure sensor, geomagnetic sensor and camera angle adjustor inside, a diver's location indicating buoy connected to the other end of the above multifunctional cable, having a first radio sending/receiving circuit inside, and a winding reel used to control the length of the multifunctional cable between the buoy and the photographing device according to the distance between the water surface and the diver;
an external device comprised of a second radio sending/receiving circuit exchanging signals with the first radio sending/receiving circuit; a display panel connected to the second radio sending/receiving circuit and receives and displays various signals including image signals received by the second radio sending/receiving circuit from the photographing part; a controller connected to the second radio sending/receiving circuit and controls the control devices by exchanging control signals through the second radio sending/receiving; and an electric power supplier which supplies power to the second radio sending/receiving circuit, display panel and controller;
wherein the multifunctional cable comprises:
electric cords, a image signal cord and one or more control cords to transfer signals of sounds, supersonic waves, temperature information or control orders with individual inner coats; and
exterior of these cords are molded or filled with flexible and durable molding resin or fibers, and the outer surface of the cable is covered with an abrasion resistant coat.

22. The underwater image video system according to claim 20, further comprising a twin lens reflex on the exterior case of said photographing device, composed of a case of each end open and with at least one or more curves, a hinge installed on the curved part of the above case, and a reflector installed on the curved part to reflect the incident ray to a set degree.

23. An underwater image video system according to claim 20, wherein the camera angle adjustor is constructed by installing the rectangular shaped fixtures driven by a motor in the photographing device so as to place each end of the fixture at each end of the photographing device case on the upper part of the photographing device, so that the camera angle is adjustable to any angle by driving said fixture through controlling the rotating direction of the motor by using the controller of the external device part.

24. The underwater image video system according to claim 20, wherein the display panel, controller and electric power supplier of the external device part is constructed by adding a connector to connect with the end of the multifunctional cable or installing a radio sending/receiving circuit which exchange signals such as image signals as image signal with the wireless radio sending/receiving circuit built in the buoy of the photographing part, to a known mobile phone with power supply unit, display unit, input unit, image storage unit and control unit.

25. The fishing equipment with video system according to claim 8, further comprising a fishing pole with an inlet hole and an outlet hole at both end parts of the fishing pole respectively, so that the multifunctional cable can pass through the fishing pole.

26. The fishing equipment with video system according to claim 9, further comprising a fishing pole with an inlet hole and an outlet hole at both end parts of the fishing pole respectively, so that the multifunctional cable can pass through the fishing pole.

27. The underwater image video system according to claim 21, further comprising a twin lens reflex on the exterior case of said photographing device, composed of a case of each end open and with at least one or more curves, a hinge installed on the curved part of the above case, and a reflector installed on the curved part to reflect the incident ray to a set degree.

28. An underwater image video system according to claim 21, wherein the camera angle adjustor is constructed by installing a rectangular shaped fixtures driven by a motor in the photographing device so as to place each end of the fixture at each end of the photographing device case on the upper part of the photographing device, so that the camera angle is adjustable to any angle by driving said fixture through controlling the rotating direction of the motor by using the controller of the external device part.

29. The underwater image video system according to claim 21, wherein the display panel, controller and electric power supplier of the external device part is constructed by adding a connector to connect with the end of the multifunctional cable or installing a radio sending/receiving circuit built in the buoy of the photographing part, to a known mobile phone with power supply unit, display unit, input unit, image storage unit and control unit.

30. A weight for the fishing equipment with video system comprising a lure shaped outer case and a built-in camera inside the lure shape case.

31. The weight for the fishing equipment with video system according to claim 30, further comprising one or more control devices selected from supersonic wave sensor, digital temperature sensor, underwater mike, pressure sensor, vibrating motor, geomagnetic sensor and camera angle adjustor.

32. The weight for the fishing equipment with video system according to claim 30, further comprising certain length of flexible tube or a thing wire on the lure shaped case, so that the user can control the location of the fishhook and shooting angle of the camera.

33. The weight for the fishing equipment with video system according to claim 30, further comprising one or more illuminators such as a high luminance illuminating diode or a infrared light.

34. The weight for the fishing equipment with video system according to claim 30, wherein the bottom part of the case is filled with materials of high density, the middle part has a built in camera, and the upper part has a void.
